(19) United States
(12) Patent Application Publication
(10) Pub. No.: US 2007/0278813 A1
(43) Pub. Date: Dec. 6, 2007

(54) Truck rear box extension and ramp

(76) Inventor: Donald D. Keehle, Utica, NY (US)

Correspondence Address: David Giglio, Esq., 231 Elizabeth Street, Utica, NY, 13501, US

(21) Appl. No.: 11/442,714

(22) Filed: May 30, 2006

(51) Int. Cl. B62D 25/00

(52) U.S. Cl. 296/61

(57) ABSTRACT

There is provided an apparatus which extends a rear box on a truck. A pair of opposing supplemental sidewalls perpendicularly extend from opposing lateral side edges on the truck tailgate. Thus, when the tailgate is opened, the interior surface of the tailgate becomes a planar extension of the truck bed, which in turn extends the length of the truck bed. At the same time the opposing supplemental sidewalls extend the length of the rear box opposing sidewalls. A supplemental tailgate folds into a superposed position over the interior surface of the tailgate when the tail gate is closed. When the tailgate is opened, the supplemental tailgate opens into a ramp and then is folded to perpendicularly extend from a rear edge of the tailgate to form a supplemental tail gate. Thus, the overall length and volume of the rear box is extended.

### FIELD OF THE INVENTION

The present invention relates generally to the field of pickup trucks and, more particularly, to an apparatus for supplementing the length of a pickup truck rear box.

### BACKGROUND OF THE INVENTION

Pickup trucks are utility vehicles that are used by many people for storing and transporting tools and various other items from place to place. A pickup truck typically contains a front cab section, which includes the engine compartment and the passenger compartment, and a rear box. The rear box is used for storing and transporting various items.

The length of a rear box is usually defined by practical considerations. Since the pickup truck must be able to fit into various parking spots, the length of the rear box can only be so long. Further, a longer rear box makes the pickup truck more difficult and inconvenient for the driver to handle.

Another negative aspect of a lengthened rear box is that it adds to the vehicle overall weight. Consequently, the added weight causes an extra strain on the engine and also results in the consumption of more fuel to drive from place to place.

The shorter rear box presents the converse problems which include less space for storing and transporting various items. For example, when one wishes to move the contents of one apartment to another more trips are necessary with a shorter rear box as opposed to longer rear box.

Further, snowmobilers often place their sleds onto a pickup truck rear box and transport the sled to a place in the country which is suitable for snowmobiling. Often times the snowmobile extends further than the bed of the rear box. Consequently, the tailgate must be kept open and the snowmobile must be tied down for transportation. Even then the snowmobile may not suitably fit into the rear box. As a result, the driver must travel slowly to get to his snowmobile destination, careful to keep the snowmobile on the bed.

### OBJECTS AND SUMMARY OF THE INVENTION

It is an object of the present invention to improve the art of transportation.

It is another object of the present invention to improve the art of pickup trucks.

It is a further object of the present invention to provide an apparatus which supplements the length of a pickup truck rear box, while adding little weight thereto.

It is yet a further object of the present invention to adapt an apparatus to an existing static pickup truck rear box which can supplement the length of the rear box.

It is a feature of the present invention to provide a lightweight structure which supplements the length of a pickup truck rear box a predetermined additional length when required and returns the length to the standard length when the additional length is not needed.

It is an additional feature of the present invention to provide a ramp that is pre-installed to the tailgate, in which the ramp also functions as a supplemental tailgate when the ramp is not needed.

These and other objects and features are provided in the present invention in which a truck includes a front cab and a rear box. The rear box contains a bed, a pair of opposing sidewalls and a tailgate.

A pair of opposing supplemental sidewalls perpendicularly extend from opposing lateral side edges on the truck tailgate. Thus, when the tailgate is opened, the interior surface of the tailgate extends the length of the truck bed, while the opposing supplemental sidewalls extend the length of the rear box opposing sidewalls. A supplemental tailgate folds into a superposed position over the interior surface of the tailgate when the tail gate is closed. When the tailgate is opened, the supplemental tailgate opens into a ramp and then is folded to perpendicularly extend from a rear edge of the tailgate to form a supplemental tail gate. Thus, the overall length and volume of the rear box is extended.

Preferably, the supplemental sidewalls and the supplemental tailgate include meshed portions to minimize any weight increases to the rear box. The supplemental sidewalls are either fixed or hinged to the tailgate.

### BRIEF DESCRIPTION OF THE DRAWINGS

The present invention will be understood and appreciated more fully from the following detailed description taken in conjunction with the drawings in which:

FIG. 1 is top view of a preferred embodiment of the pick up truck of the present invention;

FIG. 2 is a perspective side view of the rear box of the pick up truck of FIG. 1 showing a pair of supplemental sidewalls in use and a supplemental tailgate being used as a ramp;

FIG. 3 is a perspective top view of the tailgate, a supplemental sidewall and the supplemental tailgate of FIG. 1 in which the supplemental sidewall and the supplemental tailgate are connected using a pin and latch;

FIG. 4 is a perspective top view of the tailgate and a supplemental sidewall in which the two are interconnected via a ninety degree bracket;

FIGS. 5 and 6 are side elevation views of a supplemental sidewall and a standard sidewall being interconnected via a cammed groove and a cam follower;

FIG. 7 is a top perspective view of the tailgate, the supplemental tailgate and a supplemental sidewall of the present invention in which a the tailgate and the supplemental sidewall are interconnected via a hinge and a spacer plate;

FIG. 8 is a side elevation view of the extended rear box of the present invention in which the supplemental tailgate is formed of two components which allows a ramp to be extended for more convenient import and export of items onto the bed; and

FIG. 9 is a top view of the extended rear box and extended bed of the present invention.

### DETAILED DESCRIPTION OF THE PRESENT INVENTION

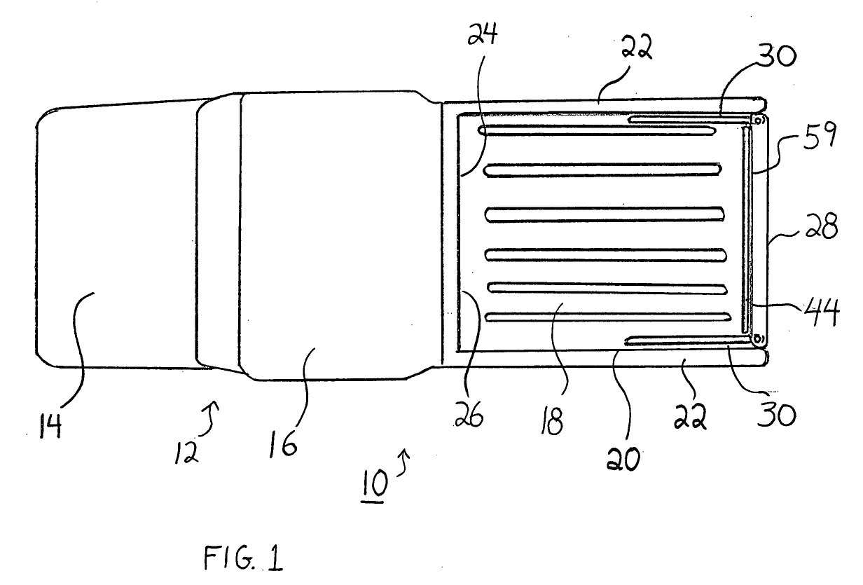

In the art of pickup trucks, in which a pickup truck 10 is depicted in FIG. 1, a front section of the truck 10 which contains an engine compartment 14 and a passenger compartment 16 is known as a cab 12. The rearward section which contains a bed 18, having a length L, for storing and hauling various items is knows as the rear box 20.

The truck rear box 20 further includes a pair of opposing sidewalls 22 perpendicularly extending upward therefrom. The bed 18 and side walls 22 are known in the art as most, if not all, truck rear boxes 20 contain a bed 18 and opposing side walls 22.

A front wall 24 extends upward perpendicularly from a front edge 26 of the bed 18. The front wall 24 is also known in the art and can be either part of a truck cab 12 or separate from the truck cab 12.

A tailgate 28 is hingedly affixed to a rear edge 31 of the bed 18. The tailgate 28 typically opens ninety degrees so that it becomes substantially a planar extension of the bed 18. This allows extension of the bed 18 to accommodate items that are too long to fit onto the bed 18 itself. Thus, the item is then tied down so that it does not fall or slide away from the bed 18 when moving.

For other items that fit into the bed 18, the tail gate 28 is opened to allow easy insertion of those items onto the bed 18. Then the tailgate 28 is closed so that the rear box 20 actually looks and functions like a box with an opened top. Thus the items now laying on the bed 18 cannot fall from the rear box 20 when moving except by going over the top of one of the opposing side walls 22 or the tail gate 28.

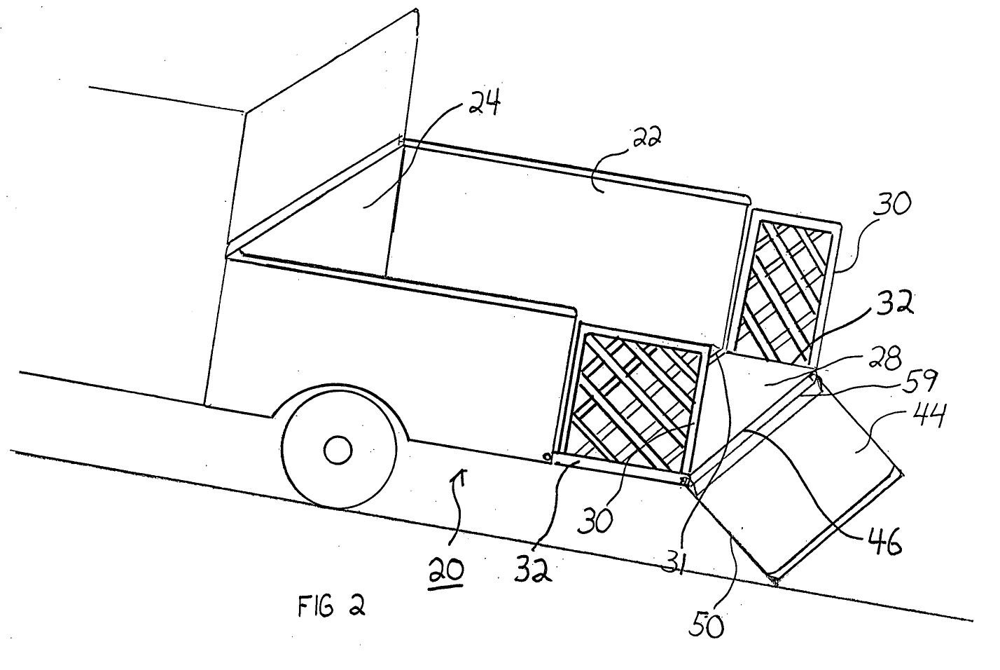

Referring now to FIG. 2, to extend the length of the rear box 20, there are provided a pair of opposing supplemental side walls 30 having a length E. These supplemental side walls 30 are perpendicularly disposed at opposing lateral edges 32 of the tailgate 28.

When the tailgate 28 is closed, the supplemental side walls 30 fit neatly just inside the opposing side walls 22 of the rear box 20, so as go virtually unnoticed, depicted in FIG. 1. When the tailgate 28 is fully opened to ninety degrees, the supplemental side walls 30 extend upward so as to become planar extensions of the opposing side walls 22. Thus, the length of the opposing side walls 22 are now extended by the length E of the supplemental sidewalls 30.

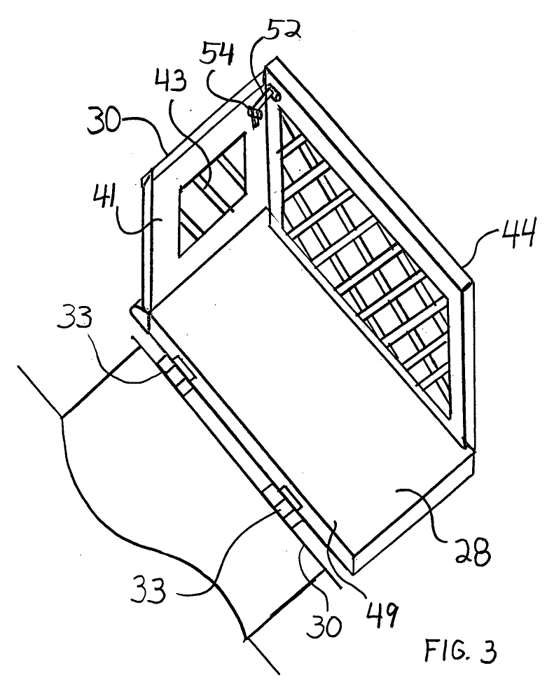

The supplemental side walls 30 are made from any suitable material, such as a metal or a plastic. Preferably, the supplemental sidewalls 3.0 have a framed boundary 41 with a central mesh or spaced member. The meshed design provide for lighter action and less stress on the tailgate hinges 33, depicted in FIG. 3.

The supplemental side walls 30 can be of permanent type fixed or molded installation to the tailgate 28, or they can be hingedly installed to the tailgate 28 as part of an add on package. In fact, a myriad of designs and apparatus for configuring the supplemental sidewalls 30 to the tailgate 28 will readily become apparent to one skilled in the art.

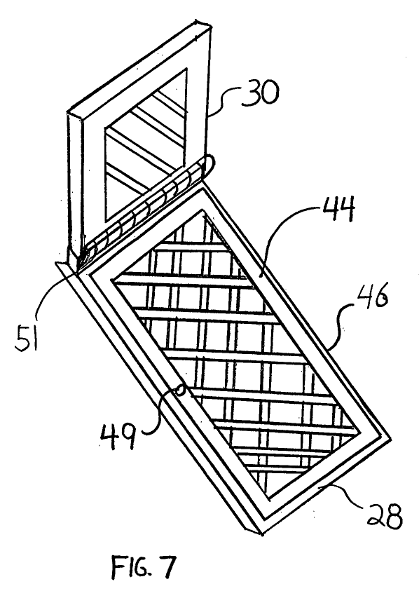

If the supplemental sidewalls 30 are hinged to the tailgate 28, depicted in FIG. 7, then the supplemental sidewalls 30 can be folded inward superposed over the tailgate 28 when the tailgate 28 is closed. When the tailgate 38 is opened, the supplemental sidewalls 30 are opened away from the tailgate and are secured to the opposing sidewalls 22 by any suitable means, or alternatively free standing in a ninety degree planar position relative to the plane of the tailgate 28.

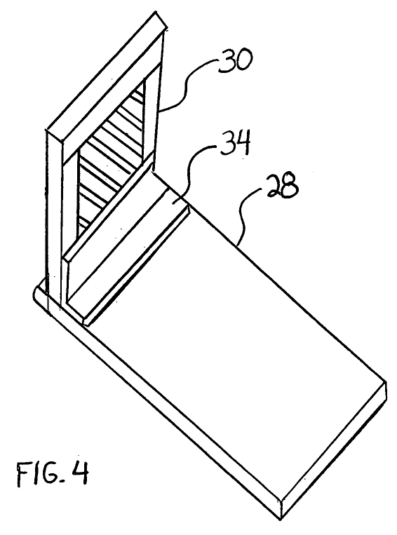

As part of an add on, ninety degree brackets 34, shown in FIG. 4, interconnect a lower frame member 36 of the supplemental side walls 30 to the tailgate 28.

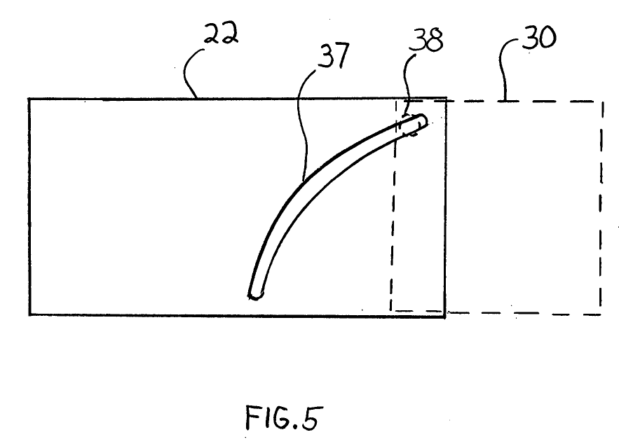

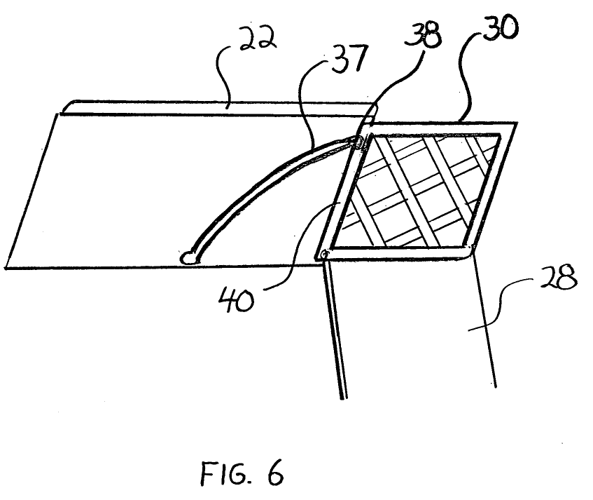

For added supplemental side wall 30 stability, the opposing side walls 22 contain a cammed groove 37, shown in FIGS. 5 and 6. The supplemental side walls 30 contain a cam follower 38 disposed off of a front frame member 40 which follows in the cammed groove 37 as the supplemental side walls 30 are opened or closed. Thus, the cam follower 38 acts as an additional structural support member to prevent inward rotation of the supplemental side walls 30.

The cammed groove 37 can be factory installed or secured to the opposing sidewalls 22 as part of an add on cam plate. One skilled in the art will realize a number of possibilities of employing and designing the cammed groove 37 to accomplished the desired features of the present invention.

A supplemental tailgate 44 is hinged to a top or rear edge 46, featured in FIG. 2, depending on the placement, of the tailgate 28. In the closed position, the supplemental tailgate 44 is also secured to a lower surface 49 of the tailgate 28, depicted in FIG. 7, so that it does not rotate about its hinge 59, depicted in FIGS. 1 and 2, when the truck 10 is moving.

Referring to FIG. 7 and previously described herein, the supplemental sidewalls 30 are installed using a rotating ninety degree hinge 51, which allows the supplemental sidewalls 30 to be rotated over the supplemental tailgate 44 when the tailgate 28 is closed. Thus, the supplemental sidewalls 30 and the supplemental tailgate 44 are all folded superposedly over the tailgate 28 when they are not needed to extend the length of the bed 18.

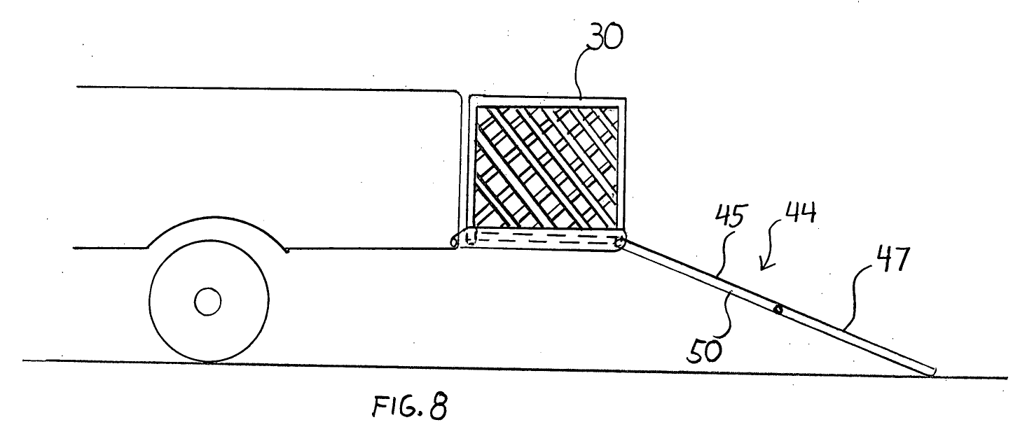

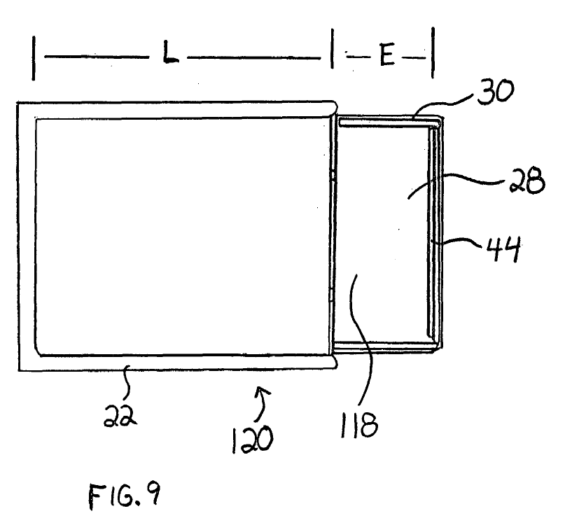

When the tailgate 28 is opened the supplemental tailgate 44 can be rotated about the rear edge 46 of the tailgate 28 to the ground so that it acts as a ramp 50. To extend the length of the ramp 50, the supplemental tailgate 44 is comprised of two members 45, 47 which are hinged to each other, depicted in FIG. 8. Thus, the length of the ramp 50 is extended which also improves the angle of entry into an extended rear box 120, shown in FIG. 9, for items that must be slid or rolled therein.

Once the items have been loaded onto a now extended bed 118, the supplemental tailgate 44 is rotated so that it extends perpendicularly upward from the now opened tailgate 28, depicted in FIGS. 3 and 9. A pair of opposing rotating latch members 52 of the supplemental tailgate 44 are rotated over inward extending pins 54, illustrated in FIG. 3, of the supplemental sidewalls 30 to prevent further rotation of the supplemental tailgate 44.

Thus, the items in the extended rear box 120 are ready for transport. Referring to FIG. 9 the length of the extended rear box increases from the length of the sidewalls 22, which was L, to the length of the sidewalls 22 plus the length of the supplemental sidewalls 30, which is now L plus E.

Like the supplemental sidewalls 30, it is preferable that the supplemental tailgate 44 be of meshed design for lighter action and less stress on the tailgate hinges 32. Further, the supplemental tailgate is also made of a suitable material such as a metal or a plastic.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What I claim is:

1. A truck rear box comprising:
a bed having a pair of opposing lateral edges, a front edge and a rear edge;
a pair of opposing sidewalls fixedly extending upward from said lateral edges;
a front surface extending upward from the front edge side;
a tailgate hinged adjacent to the rear edge, said tailgate including a pair or opposing lateral edges and a top edge;
a pair of opposing supplemental side walls perpendicularly extending from said opposing tailgate lateral edges; and
a supplemental tailgate member hingedly affixed to said tailgate.

2. The truck rear box of claim 1, wherein said supplemental tailgate member further includes a plurality of sections extending angularly from the top edge of said tailgate to the ground, wherein each of said plurality of sections is juxtaposed to an adjacent section.

3. The truck rear box of claim 1, wherein said supplemental tailgate member further includes a plurality of sections and wherein each of said plurality of sections is superposed over an adjacent section.

4. The truck rear box of claim 1, further including a supplemental tailgate securing means for securing said supplemental tailgate member to said tailgate in a superposed position when said tailgate is closed.

5. The truck rear box of claim 1, further including at least one supplemental sidewall securing means for securing at least one of said opposing supplemental sidewalls to said tailgate.

6. The truck rear box of claim 5, wherein said at least one supplemental sidewall securing means includes at least one hinge member such that said at least one of said opposing supplemental sidewalls is hinged to said tailgate.

7. The truck rear box of claim 5, wherein said at least one supplemental sidewall securing means includes at least one static securing means for securing said at least one of said opposing supplemental sidewalls to said tailgate.

8. The truck rear box of claim 1, wherein at least one of said opposing sidewalls includes a cam member disposed thereto, and wherein said at least one of said opposing supplemental sidewalls includes a cam follower disposed therefrom, wherein said cam follower is moveable in said cam member.

9. The truck rear box of claim 1, wherein at least one of said opposing sidewalls and at least one of said opposing supplemental sidewalls includes at least one mating means for securing said at least one of said opposing supplemental sidewalls to said at least one of said opposing sidewalls to prevent said at least one of said opposing supplemental sidewalls from rotating away from said at least one of said sidewalls.

10. The truck rear box of claim 1, wherein said supplemental tailgate member and at least one of said supplemental sidewalls include mating means for securing said supplemental tailgate member to said at least one of said supplemental sidewalls when said tailgate is opened.

11. A truck comprising:
an engine compartment;
a passenger compartment; and
a rear box, wherein said rear box comprises:
a bed having a pair of opposing lateral edges, a front edge and a rear edge;
a pair of opposing sidewalls fixedly extending upward from said lateral edges;
a front surface extending upward from the front edge side;
a tailgate hinged adjacent to the rear edge, said tailgate including a pair or opposing lateral edges and a top edge;
a pair of opposing supplemental side walls perpendicularly extending from said opposing tailgate lateral edges; and
a supplemental tailgate member hingedly affixed to said tailgate.

12. The truck rear box of claim 1, wherein said supplemental tailgate member further includes a plurality of sections extending angularly from the top edge of said tailgate to the ground, wherein each of said plurality of sections is juxtaposed to an adjacent section.

13. The truck rear box of claim 11, wherein said supplemental tailgate member further includes a plurality of sections and wherein each of said plurality of sections is superposed over an adjacent section.

14. The truck rear box of claim 11, further including a supplemental tailgate securing means for securing said supplemental tailgate member to said tailgate in a superposed position when said tailgate is closed.

15. The truck rear box of claim 11, further including at least one supplemental sidewall securing means for securing at least one of said opposing supplemental sidewalls to said tailgate.

16. The truck rear box of claim 15, wherein said at least one supplemental sidewall securing means includes at least one hinge member such that said at least one of said opposing supplemental sidewalls is hinged to said tailgate.

17. The truck rear box of claim 15, wherein said at least one supplemental sidewall securing means includes at least one static securing means for securing said at least one of said opposing supplemental sidewalls to said tailgate.

18. The truck rear box of claim 11, wherein at least one of said opposing sidewalls includes a cam member disposed thereto, and wherein said at least one of said opposing supplemental sidewalls includes a cam follower disposed therefrom, wherein said cam follower is moveable in said cam member.

19. The truck rear box of claim 11, wherein at least one of said opposing sidewalls and at least one of said opposing supplemental sidewalls includes at least one mating means for securing said at least one of said opposing supplemental sidewalls to said at least one of said opposing sidewalls to prevent said at least one of said opposing supplemental sidewalls from rotating away from said at least one of said sidewalls.

20. The truck rear box of claim 11, wherein said supplemental tailgate member and at least one of said supplemental sidewalls include mating means for securing said supplemental tailgate member to said at least one of said supplemental sidewalls when said tailgate is opened.
